(19) United States
(12) Patent Application Publication
(10) Pub. No.: US 2025/0266729 A1
(43) Pub. Date: Aug. 21, 2025

(54) ELECTRIC DRIVE WITH TOROIDAL COIL CARRIER

(71) Applicant: BOMATEC MANAGEMENT AG, Höri (CH)

(72) Inventor: Mike KÖNIGS, Flensburg (DE)

(21) Appl. No.: 18/857,667

(22) PCT Filed: Apr. 26, 2022
(86) PCT No.: PCT/EP2022/061101

§ 371 Date: Oct. 17, 2024

(51) Int. Cl. H02K 3/48

(52) U.S. Cl. CPC H02K 3/48

(57) ABSTRACT

An electric drive comprises a stator and a rotor and a plurality of coils of a winding. The stator a toroidal coil carrier, the cross-sectional area of the toroidal coil carrier having the shape of an ellipse, in particular a circle. The coils of the winding are wound around sections of the toroidal coil carrier.

### CROSS-REFERENCE TO RELATED APPLICATIONS

This application is a Continuation of International Application No. PCT/EP2022/061101, filed Apr. 26, 2022, designating the U.S. all of which is incorporated herein by reference in its entirety.

### FIELD OF THE INVENTION

The invention relates to an electric drive with a stator and a rotor. This formulation includes, in particular, the case of a radial flux machine with exactly one stator and exactly one rotor and, in particular, the case of an axial flux machine with two stators and one rotor. There is also a large number of coils.

### BACKGROUND

An electric drive is an electrical machine that converts electrical power into mechanical power. Current-carrying conductor coils generate magnetic fields whose mutual forces of attraction and repulsion are converted into movement. The so-called internal rotor has a stationary outer part and a rotating inner part. These parts are called the stator and rotor.

Electric motors are used in industry, e.g. in the packaging and food industry, in robotics, in medical technology and in medical aids or also in mobility, e.g. electric bicycles, small vehicles, small aircraft.

Conventionally, rectangular tooth structures with side lengths l₁ and I₂ are used for the stator geometry, especially for tooth coil windings, where I₁ is usually much larger than I₂. The side length I₁ is regarded as a torque-forming winding and the side length I₂ is regarded as an undesired winding head. On the one hand, the change in the magnetic flux and thus its amplitude should be maximized and, on the other hand, current heat losses in the winding should be minimized.

### DISCLOSURE OF THE INVENTION

The object is to provide an electric drive which has a physically and mathematically optimized winding geometry.

This object is solved by the subject of the independent claim. Accordingly, an electric drive comprises a stator and a rotor. The stator is stationary and the rotor moves. The rotor rotates the drive shaft. The electric drive comprises a plurality of windings of a winding wire, which are wound into coils. In particular, the winding wire usually consists of a copper wire, especially an enameled copper wire.

The electric drive comprises a toroidal coil carrier, whereby the coils of the winding wire are wound around sections of the toroidal coil carrier and are supported by it. The terms toroidal coil carrier or toroidal body stand for a rotating body with a hole in the center. The axis of rotation passes through the hole and does not cross the body of rotation. Any cross-sectional area, e.g. a square, can be rotated. If a cross-sectional area is rotated in the form of a circle, the toroidal body is called a “torus”. The cross-sectional area of the toroidal coil carrier has the shape of an ellipse, in particular a circle.

The application of coils around “sections” of the toroidal coil carrier means that coils are not present along the entire area of rotation, but only in sections.

A circle as a cross-sectional area has the largest surface area with the smallest possible circumference of all geometric 2D shapes. This minimizes the length of the enclosing wire. Consequently, the current heat losses in the winding wire, which is wound in a circle around the toroidal coil carrier, are also minimized. This is because the amount of current heat loss is a function of the length of the winding wire. Alternatively, if the cross-sectional area is not designed as a circle but as an ellipse, the geometry is not optimal, but still better than with rectangular tooth structures in conventional electric drives.

Advantageously, the stator has a lamella structure with a number of lamellae. The coils are each wound between the lamellae around the sections of the toroidal coil carrier. In particular, the toroidal coil carrier and the lamella structure are designed together as a stator. For larger stator geometries, the stator can be assembled and bonded from individual segments or from a plurality of sections.

The addition of a lamella structure to the toroidal coil carrier enables the use of conventional rotor structures. These can be either axial flux rotors or radial flux rotors. Without a lamella structure, an electric drive as described could only be produced with immense manufacturing effort.

In particular, the lamellae extend in the direction of the axis of rotation of the toroidal coil carrier over a greater length than the toroidal coil carrier. This provides a large stator that can accommodate the main magnetic flux from the rotor and makes it possible to use conventional rotor structures.

In particular, when designed as a radial flux machine, the lamellae extend in the direction of the axis of rotation of the toroidal coil carrier over a length at least twice as long, in particular over a length at least three times as long, as the toroidal coil carrier.

Advantageously, the lamella structure is designed as a toroidal body. The lamellae represent sections of the toroidal body. The sections for the individual coil formers of the winding are arranged between these sections of the lamellae.

In particular, the axis of rotation of the toroidal coil carrier is identical to the axis of rotation of the toroidal body of the lamella structure.

Advantageously, the toroidal body has a cross-sectional area that is at least three times as large, in particular at least five times as large, as the cross-sectional area of the toroidal coil former. As a result, the stator has a large air gap area to accommodate the main magnetic flux from the rotor.

Advantageously, the maximum radial extension of the toroidal coil carrier is the same size as the maximum radial extension of the toroidal body of the lamella structure, in each case starting from the axis of rotation. In other words, the toroidal coil carrier and the lamella structure, which together form the stator in particular, are flush with each other on the respective outer sides. This design is provided in particular for an internal rotor.

Alternatively, the minimum radial extension of the toroidal coil carrier can be the same size as the minimum radial extension of the toroidal body of the lamella structure, in each case starting from the axis of rotation. This design is particularly suitable for an external rotor.

Such a geometric configuration of the stator has the advantage that the coils wound from the winding wire partially protrude from the lamella structure and are therefore easily accessible for cooling.

In other words, the coils of the winding extend into an area that is radially further away from the axis of rotation than a radially outermost area of the lamella structure. This configuration is provided in particular for an internal rotor.

Alternatively, the winding can extend into an area that is radially less distant from the axis of rotation than the radially innermost area of the lamella structure.

In particular, the electric drive comprises exactly one stator and exactly one rotor in the radial flux machine version and exactly two stators and exactly one rotor in the axial flux machine version.

The toroidal coil carrier advantageously has a maximum annular ring diameter of at most 200 mm, in particular at most 100 mm, and/or at least 60 mm, in particular at least 80 mm. If the toroidal coil carrier has the cross-sectional shape of a circle, the diameter of the circle is in particular larger than 5 mm, in particular larger than 10 mm and/or smaller than 20 mm, in particular smaller than 15 mm.

In particular, the stator surrounds the rotor, i.e. the rotor is arranged in the core of the stator. This is a so-called internal rotor. Alternatively, the rotor surrounds the stator. This is known as an external rotor. The rotor is preferably a radial flux rotor.

If the cross-sectional area of the toroidal coil carrier has the shape of an ellipse, the large axis of the ellipse is at most 1.3 times, in particular at most 1.2 times, as long as the small axis of the ellipse.

The stator consists of a 3D flux-conducting material with measures to reduce eddy currents. Examples include soft magnetic powder composites (SMC), ferrites or nanocrystalline materials.

### BRIEF DESCRIPTION OF THE DRAWINGS

Further embodiments, advantages and applications of the invention are shown in the dependent claims and in the following description with reference to the figures. The figures show

FIG. 1a a first electric drive in a radial arrangement as an internal rotor;

FIG. 1b the stator of the first electric drive without the coils of the stator winding;

FIG. 1c the stator without the coils of the stator winding as seen from above;

FIG. 1d a section through the stator without the coils of the stator winding according to the section line drawn in FIG. 1c;

FIG. 1e the stator without the coils of the stator winding as seen from the side;

FIG. 1f a sectional view of the stator along the sectional line shown in FIG. 1e, with the hatched areas representing the coils of the stator winding;

FIG. 2a a second electric drive in a radial arrangement as an external rotor;

FIG. 2b the stator of the second electric drive without the coils of the stator winding;

FIG. 2c the stator without the coils of the stator winding as seen from above;

FIG. 2d a section through the stator without the coils of the stator winding according to the section line drawn in FIG. 2c;

FIG. 2e the stator without the coils of the stator winding as seen from the side;

FIG. 2f a section through the stator along the sectional line shown in FIG. 2e, with the hatched areas representing the coils of the stator winding;

FIG. 3a a third electric drive in an axial arrangement;

FIG. 3b a stator part of the third electric drive;

FIG. 3c the stator part with a view of the flat surface;

FIG. 3d the stator part viewed from the side; and

FIG. 4 the cross-sectional area of a toroidal coil carrier in an alternative embodiment in the geometry of an ellipse.

### DETAILED DESCRIPTION

### Ways of Carrying out the Invention

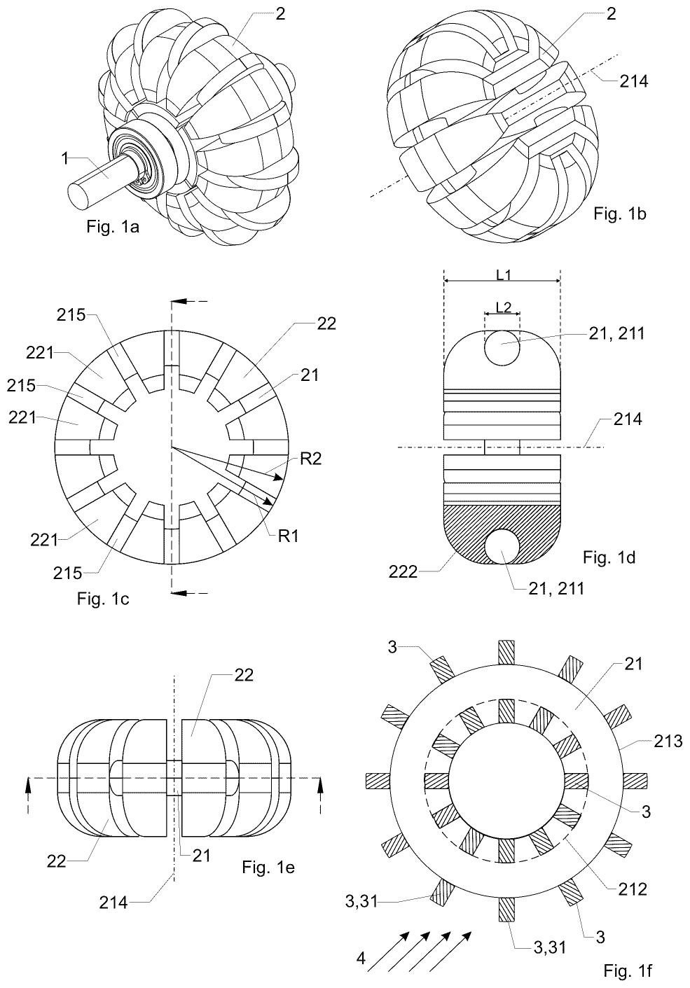

FIG. 1a shows a first electric drive. This comprises a rotor 1 and a stator 2. FIGS. 1b to 1f show only the stator 2, with the coils of the winding 3 being shown as a hatched area in FIG. 1f.

The stator 2 comprises a toroidal coil carrier 21. The toroidal coil carrier 21 is a body of revolution which rotates a cross-sectional area 211. In the present embodiment, the cross-sectional area 211 is a circle with an exemplary radius of 6 mm. A coil 3 is wound around the toroidal coil carrier 21. As mentioned, this is illustrated in FIG. 1f by the hatched area.

Only that part of the stator 2 around which the coils of the winding are wound is referred to as toroidal coil carrier 21. In the present embodiment, this is a torus, which in FIG. 1f is bounded on the inside by the dashed line 212 and on the outside by the circular solid line 213.

The toroidal coil carrier 21 is supplemented by a lamella structure 22. The stator 2 thus comprises the toroidal coil carrier 21 and the lamella structure 22. The stator 2 is designed in one piece, but can consist of bonded subsegments.

Sections 215 of the toroidal coil carrier 21, around which coils 3 are wound, are exposed between the lamellae 221. In other words, the coils 3 do not surround the toroidal coil carrier 21 along the entire circular ring, but only in the sections 215 between the lamellae 221. In the present embodiment, the stator 2 or the laminated structure 22 comprises a total of twelve lamellae 221 and twelve sections 215 of the toroidal coil carrier 21 between the laminations 221.

In the direction of the axis of rotation 214, the lamellae 221 extend over a greater length L1, which is for example 40 mm, than the toroidal coil carrier 21 over a length L2. The length L1 is approximately three times as great as the length L2.

The lamella structure 22 is also a toroidal body in the present embodiment. This is because the lamella structure 22 is a body of revolution, in which the cross-sectional area 222 hatched in FIG. 1d is rotated about the axis of rotation 214. The axes of rotation of the toroidal coil carrier 21 and the lamella structure 22 are identical. However, the lamella structure 22 is not continuous along the circular ring, but is only present in sections. These sections of the lamella structure 22 are the lamellae 221. The toroidal body of the lamella structure 22 is interrupted between the lamellae, so that intermediate spaces are formed for the coils of the winding 3.

The cross-sectional area 222 of the toroidal body of the lamella structure 22 is approximately six to seven times as large as the cross-sectional area 211 of the toroidal coil carrier 21. As a result, the stator 2 has a large air gap area to accommodate the main magnetic flux from the rotor.

The maximum radial extension R1 of the toroidal coil carrier 21 is exactly the same size as the maximum radial extension R2 of the lamella structure 22. This has the positive effect that the part 31 of the coils 3 is exposed outside the stator 2 and is easily accessible there for cooling 4. In other words, the coils of the winding 3 extend into an area which is radially further outwards from the axis of rotation 214 than a radially outermost area of the lamella structure 22. The radii R1 and R2 in this exemplary embodiment are 40 mm and correspond to the maximum annular diameter of the toroidal coil carrier 21 and the toroidal body of the lamella structure 22.

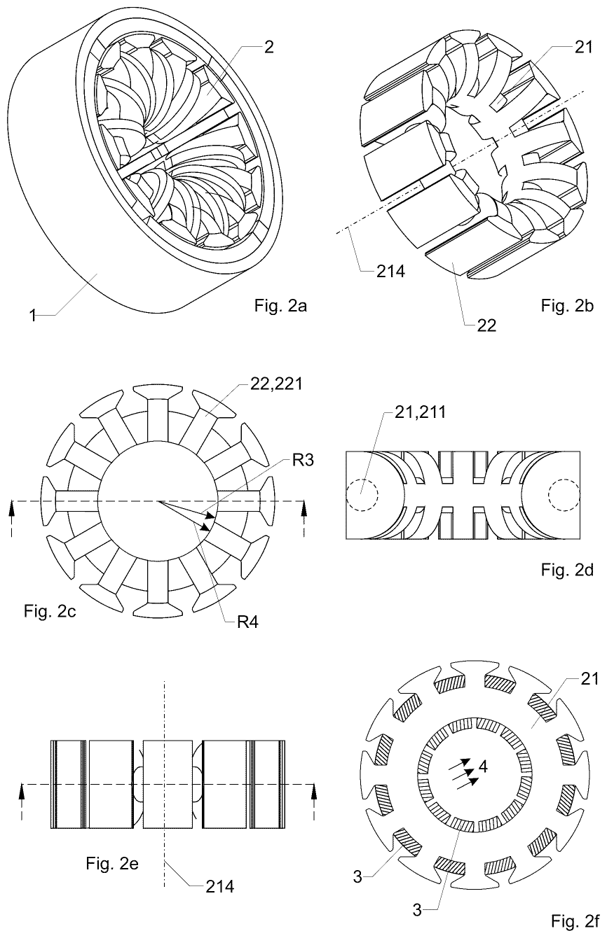

FIG. 2a shows a second electric drive. This also comprises exactly one rotor 1 and exactly one stator 2. FIGS. 2b to 2f show only the stator 2, whereby in FIG. 2f the winding 3 is shown in a hatched area. The reference signs are used in the same way as in FIGS. 1a to 1f. Since the rotor 1 surrounds the stator 2, it is a so-called “external rotor”.

The stator 2 is designed according to the same principles as the stator 2 of the first electric drive. It also comprises a toroidal coil carrier 21 with a circular cross-sectional area 211, around which the coils that make up the winding are mounted in sections.

One difference to the first electric drive is that the minimum radial extension R3 of the toroidal coil carrier 21 is exactly the same size as the minimum radial extension R3 of the lamella structure 22. This has the positive effect that the part 31 of the winding 3 is exposed inside the stator 2 and is easily accessible there for cooling 4. In other words, the winding 3 extends into an area that is radially further inwards from the axis of rotation 214 than a radially innermost area of the fin structure 22.

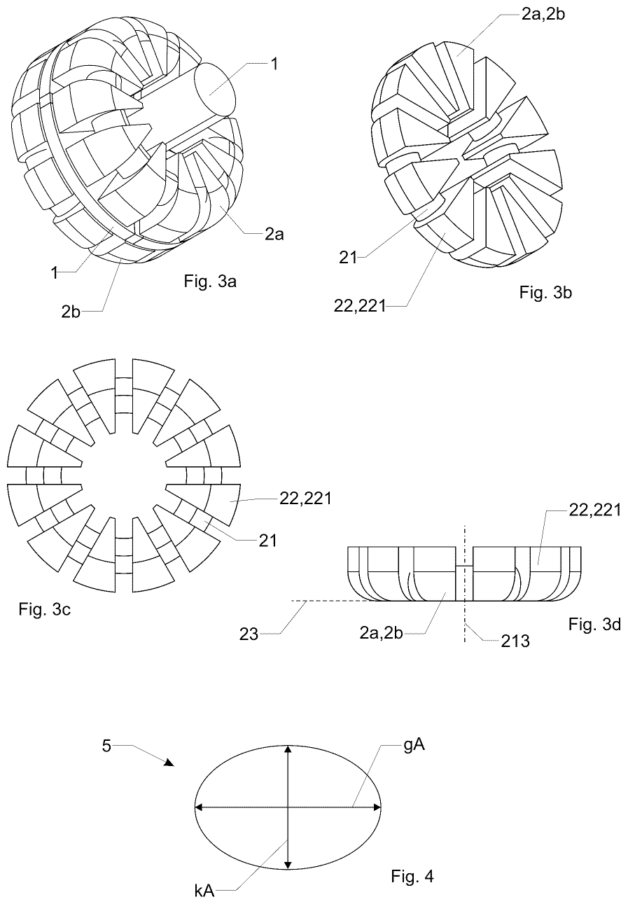

FIGS. 3a to 3d show an internal rotor in an axial arrangement. This comprises a rotor 1 and a stator 2 with two stator parts 2a and 2b. Both stator parts 2a and 2b are constructed according to the same principles as the stators of the first and second electric drive. One difference is that the toroidal coil carrier 21 is not flush with the outermost side of the lamella structure 22 in the radial direction, but in the axial direction. The toroidal coil carrier 21 and the lamella structure 22 are flush at the dashed line 23.

FIG. 4 shows an ellipse 5. In a particular embodiment, the cross-sectional area 211 of the toroidal coil carrier 21 can have the shape of such an ellipse 5. For example, the ellipse has a large axis gA, which is 1.2 times as long as the small axis kA.

If the cross-sectional area of the toroidal coil carrier has the shape of an ellipse, the large axis of the ellipse is in particular at most 1.3 times, in particular at most 1.2 times, as long as the small axis of the ellipse.

Whilst preferred embodiments of the invention are described in the present application, it should be clearly pointed out that the invention is not limited to these and can also be carried out in other ways within the scope of the following claims.

1. An electric drive comprising:
a stator and a rotor and a plurality of coils of a winding,
wherein the stator has a toroidal coil carrier with an axis of rotation and the toroidal coil carrier has a cross-sectional area of an ellipse, in particular of a circle, the coils of the winding being wound around sections of the toroidal coil carrier.

2. The electric drive according to claim 1,
wherein the stator has a lamella structure with a plurality of lamellae, and
wherein the coils of the winding are applied between the lamella around the sections of the toroidal coil carrier.

3. The electric drive according to claim 2, wherein the lamellae extend in a direction of the axis of rotation of the toroidal coil carrier over a greater length than the toroidal coil carrier.

4. The electric drive according to claim 3, wherein the lamellae extend in the direction of the axis of rotation of the toroidal coil carrier over a length at least twice as long, in particular at least three times as long, as the toroidal coil carrier.

5. The electric drive according to claim 3,
wherein the lamella structure is adapted as a toroidal body, and
wherein the lamellae are sections of the toroidal body and between these sections there are intermediate spaces for the coils of the winding.

6. The electric drive according to claim 5, wherein the axis of rotation of the toroidal coil carrier is identical to the axis of rotation of the toroidal body of the lamella structure.

7. The electric drive according to claim 5, wherein the toroidal body has a cross-sectional area which is at least three times as large, in particular at least five times as large, as the cross-sectional area of the toroidal coil carrier.

8. The electric drive according to claim 5,
wherein a maximum radial extension of the toroidal coil carrier is a same size as a maximum radial extension of the toroidal body of the lamella structure, in each case starting from the axis of rotation, or
wherein a minimum radial extension of the toroidal coil carrier is equal to a minimum radial extension of the toroidal body of the lamella structure, in each case starting from the axis of rotation.

9. The electric drive according to claim 3,
wherein the winding extends into a region which is radially further away from the axis of rotation than a radially outermost region of the lamella structure, or
wherein the winding extends into a region which is radially less distant from the axis of rotation than a radially innermost region of the lamella structure.

10. The electric drive according to claim 1, comprising
exactly one stator and exactly one rotor, or
exactly two stators and exactly one rotor.

11. The electric drive according to claim 1, wherein the toroidal coil carrier has a maximum annular ring diameter and the maximum annular ring diameter is at most 200 mm, in particular at most 100 mm, and/or is at least 60 mm, in particular at least 80 mm, in size.

12. The electric drive according to claim 1, wherein the stator surrounds the rotor or wherein the rotor surrounds the stator.

13. The electric drive according to claim 1, wherein the rotor is a radial flux rotor or an axial flux rotor.

14. The electric drive according to claim 1, wherein an elliptical shape of the cross-sectional area of the toroidal coil carrier has a large axis and a small axis, wherein the large axis is at most 1.3 times, in particular at most 1.2 times, as long as the small axis.
